(19) United States
(12) Patent Application Publication
(10) Pub. No.: US 2016/0065480 A1
(43) Pub. Date: Mar. 3, 2016

(54) CONTROLLING APPLICATION TRAFFIC

(71) Applicant: QUALCOMM Incorporated, San Diego, CA (US)

(72) Inventors: Stefano Faccin, Hayward, CA (US); Edward Robert Hall, Bristol (GB)

(21) Appl. No.: 14/617,126

(22) Filed: Feb. 9, 2015

Related U.S. Application Data
(60) Provisional application No. 62/045,448, filed on Sep. 3, 2014.

(51) Int. Cl. H04L 12/813; H04L 12/911; H04L 12/927; H04L 12/801

(52) U.S. Cl. CPC H04L 47/20; H04L 47/11; H04L 47/14; H04L 47/822; H04L 47/805

(57) ABSTRACT

A wireless communication device controls whether an application can access a service provided by a server. The wireless communication device maintains a policy that specifies a particular action (e.g., blocking traffic) to be taken at the wireless communication device if a particular network condition occurs (e.g., congestion at a server). The wireless communication device also monitors network conditions (e.g., in real-time) so that it can take appropriate action whenever a trigger condition occurs according to the policy. In some scenarios, the policy supports mission-critical applications.

### CROSS-REFERENCE TO RELATED APPLICATION(S)

This application claims priority to and the benefit of provisional patent application No. 62/045,448 filed in the U.S. patent office on Sep. 3, 2014, the entire content of which is incorporated herein by reference.

### BACKGROUND

1. Field of the Disclosure

Aspects of the disclosure relate generally to communication, and more specifically, but not exclusively, to controlling application traffic.

2. Description of Related Art

With the spread of applications on mobile devices (e.g., “smart phones”), coupled with the rapidly growing number of devices designed for use with little or no human involvement (machine type communications), there is an increased potential for issues to occur in an operator's wireless network involving these applications and third-party entities with which the applications interact. If these third party systems experience difficulties, they may be able to manage their problems without undue impact on the operator's network; however, there will be times when they are not able to do so.

In some scenarios, servers providing a service may fail. Due to the protocols used (e.g., protocols above the Internet protocol (IP) layer, such as Session Initiation Protocol (SIP)-based protocols or Hypertext Transfer Protocol (HTTP)-based protocols), there may be an impact on the servers when a large number of client applications in mobile devices attempt to reconnect to the servers. Furthermore, there may be an impact on the network in terms of a surge in traffic. For example, in some scenarios, devices continue (in vain) to reattempt the connection, thus generating excessive traffic that impacts the servers and the underlying wireless network.

### SUMMARY

The following presents a simplified summary of some aspects to provide a basic understanding of such aspects. This summary is not an extensive overview of all contemplated features of the disclosure, and is intended neither to identify key or critical elements of all aspects nor to delineate the scope of any or all aspects. Its sole purpose is to present various concepts of some aspects in a simplified form as a prelude to the more detailed description that is presented later.

Various aspects provide for controlling whether an application at a wireless communication device can access a service provided by a server. The wireless communication device can include, for example and without limitation, a mobile device such as a user equipment (UE) or a device that employs machine type communication. The wireless communication device maintains a policy that specifies a particular action (e.g., blocking access to a service) to be taken at the wireless communication device if a particular network condition occurs (e.g., network congestion associated with the service). In addition, the wireless communication device monitors network conditions (e.g., congestion at a server) over time. In this way, the wireless communication device can take appropriate action whenever a trigger condition occurs according to the policy.

In some scenarios, the policy supports mission-critical applications that require, for example, ultra-low latency. To support such mission-critical applications, traffic from non-mission-critical applications can be selectively limited (e.g., blocked) at a wireless communication device, to provide sufficient connectivity and/or quality of service for the mission-critical applications.

In one aspect, the disclosure provides a method operable at a wireless communication device for controlling traffic including receiving a traffic routing policy; receiving an indication of congestion at a server; and determining whether to control traffic flow to the server based on the traffic routing policy and the indication of congestion.

Another aspect provides an apparatus for controlling traffic at a wireless communication device, the apparatus including a memory circuit and a processing circuit coupled to the memory circuit. The processing circuit is configured to receive a traffic routing policy; receive an indication of congestion at a server; and determine whether to control traffic flow to the server based on the traffic routing policy and the indication of congestion.

Another aspect provides an apparatus for controlling traffic at a wireless communication device. The apparatus including means for receiving, the means for receiving configured to receive a traffic routing policy and receive an indication of congestion at a server; and means for determining whether to control traffic flow to the server based on the traffic routing policy and the indication of congestion.

Another aspect provides a non-transitory computer-readable medium storing computer executable code for controlling traffic at a wireless communication device, including code to receive a traffic routing policy; receive an indication of congestion at a server, and determine whether to control traffic flow to the server based on the traffic routing policy and the indication of congestion.

Further to the above, in accordance with additional aspects, traffic flow from an application to the server may be limited as a result of the determination. In accordance with additional aspects, the limiting of traffic flow may include completely blocking the traffic flow or blocking a specific access by the application. In accordance with additional aspects, the traffic routing policy includes at least one of: an application identifier, a service identifier, or a domain identifier. In accordance with additional aspects, the traffic routing policy indicates traffic to be controlled, and flow of the indicated traffic from an application to the server may be controlled as a result of the determination. In accordance with additional aspects, the traffic routing policy includes an expression pattern defining at least one traffic control criterion. In accordance with additional aspects, the traffic routing policy indicates a preferred access for particular traffic, and the particular traffic may be routed according to the indicated preferred access. In accordance with additional aspects, the indicated preferred access overrides a corresponding traffic routing policy previously configured at the wireless communication device. In accordance with additional aspects, the traffic routing policy indicates a class, a class associated with the wireless communication device is identified, and access to the server by an application or the device is controlled if the identified class matches the indicated class. In accordance with additional aspects, each class relates to at least one of: a device class, a subscription class, or an application class. In accordance with additional aspects, a determination is made as to whether the indication is different from a previously received indication of congestion, and evaluation of the traffic routing policy is triggered based on the determination of whether the indication is different. In accordance with additional aspects, another indication is sent to an upper protocol layer indicating that connectivity for a particular application is not available, wherein the other indication is sent as a result of the determination.

These and other aspects will become more fully understood upon a review of the detailed description, which follows. Other aspects, features, and implementations will become apparent to those of ordinary skill in the art, upon reviewing the following description of specific implementations in conjunction with the accompanying figures. While features may be discussed relative to certain implementations and figures below, all implementations can include one or more of the advantageous features discussed herein. In other words, while one or more implementations may be discussed as having certain advantageous features, one or more of such features may also be used in accordance with the various implementations discussed herein. In similar fashion, while certain implementations may be discussed below as device, system, or method implementations it should be understood that such implementations can be implemented in various devices, systems, and methods.

### BRIEF DESCRIPTION OF THE DRAWINGS

FIG. 1 illustrates an exemplary apparatus for controlling traffic in accordance with some aspects.

FIG. 2 illustrates an exemplary system where traffic associated an application is controlled in accordance with some aspects.

FIG. 3 illustrates an exemplary apparatus where an application blocking indication is generated in accordance with some aspects.

FIG. 4 illustrates an exemplary apparatus where application access to a service is controlled based on an application blocking indication in accordance with some aspects.

FIG. 5 illustrates an exemplary process for evaluating policy in accordance with some aspects.

FIG. 6 illustrates another exemplary process for evaluating policy in accordance with some aspects.

FIG. 7 illustrates an exemplary apparatus where an expression pattern is generated in accordance with some aspects.

FIG. 8 illustrates an exemplary apparatus where application access to a service is controlled based on an expression pattern in accordance with some aspects.

FIG. 9 illustrates an exemplary apparatus where a connectivity indication is sent to an upper layer component in accordance with some aspects.

FIG. 10 illustrates a block diagram of an exemplary hardware implementation for an apparatus that supports traffic control in accordance with some aspects.

FIG. 11 illustrates an exemplary process for supporting traffic control in accordance with some aspects.

FIG. 12 illustrates an exemplary process for limiting traffic flow in accordance with some aspects.

FIG. 13 illustrates an exemplary process for controlling traffic flow in accordance with some aspects.

FIG. 14 illustrates an exemplary process for routing traffic in accordance with some aspects.

FIG. 15 illustrates an exemplary process for controlling access based on a class in accordance with some aspects.

FIG. 16 illustrates an exemplary process for evaluating traffic routing policy in accordance with some aspects.

FIG. 17 illustrates an exemplary process for sending an indication to an upper protocol layer in accordance with some aspects.

FIG. 18 illustrates a first exemplary process for supporting traffic control in accordance with some aspects.

FIG. 19 illustrates a second exemplary process for supporting traffic control in accordance with some aspects.

FIG. 20 illustrates a third exemplary process for supporting traffic control in accordance with some aspects.

FIG. 21 illustrates a fourth exemplary process for supporting traffic control in accordance with some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

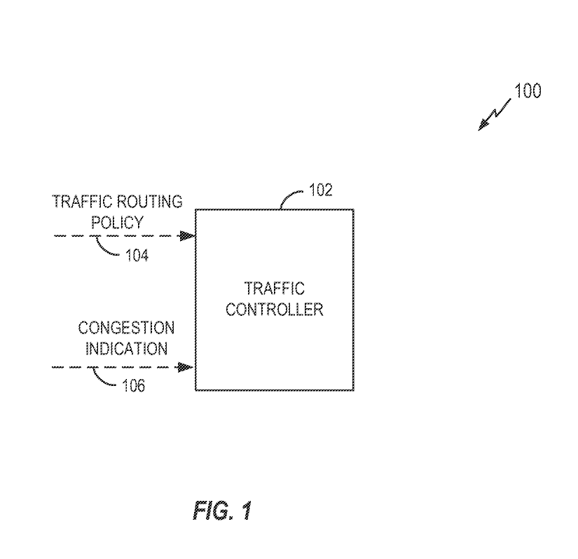

FIG. 1 illustrates an apparatus 100 (e.g., a wireless communication device) that includes a traffic controller 102 for controlling traffic at the apparatus 100. In particular, the traffic controller 102 controls traffic (e.g., blocks or routes traffic) based on a received traffic routing policy 104 and a received congestion indication 106.

For example, in the event a server (e.g., a third-party server) becomes congested or fails, it is desirable to control the communication by any applications on any wireless communication devices (e.g., UEs) that make use of that server so that excessive use of network resources is avoided. In this way, a network can prevent the wireless communication device from attempting frequent retries that most likely will fail and thereby burden the network with failed connection attempts. Advantageously, this application traffic can be controlled without adversely affecting other applications and their associated servers that are functioning normally.

A server may be dedicated to a particular wireless communication device application or it may support multiple wireless communication device applications. In either case, by limiting the ability of the application(s) to access a service during times of congestion or other failure events, network problems associated with futile connection attempts can be mitigated.

The disclosure relates in some aspects to mitigating network problems by controlling whether an application at a wireless communication device can access a service. A network can detect or receive indications from servers that indicate the servers' congestion status or failure status, and selectively control applications that make use of a server that has encountered difficulties. The network can also generate a policy that specifies a particular action (e.g., blocking access to a service) to be taken at a wireless communication device if a particular condition occurs (e.g., network congestion associated with the service). Advantageously, this action can be directed to those wireless communication device applications that use the service, without adversely affecting other applications of the wireless communication device. This action can also be directed to a specific subset of those wireless communication device applications that use the service, e.g., based on specific subscription or device capabilities or device type, without adversely affecting other applications of the wireless communication device. A wireless communication device that receives such a policy from the network can thereby monitor conditions (e.g., in real time), and take the appropriate action whenever a trigger condition occurs.

In the event a trigger condition occurs, a wireless communication device may indicate to a user that one or more applications are temporarily unavailable. In this way, the user may refrain from further attempts to use the application(s), particularly when it is unlikely that the user would receive the service anyway.

The disclosure also relates in some aspects to supporting mission-critical applications at a wireless communication device. Mission-critical applications (e.g., in 5G networks) are applications that require ultra-low latency and are highly sensitive to delays and congestion, as compared to other applications. To support such mission-critical applications, a traffic routing policy may indicate that specific traffic from specific non-mission-critical applications is to be selectively limited (e.g., blocked). In some aspects, this may involve limiting (e.g., blocking) any devices (e.g., applications on the devices) that are causing congestion that adversely affects a mission-critical application. In contrast, the traffic routing policy may indicate that any mission-critical applications that need connectivity at this time can be enabled and thereby receive an acceptable level of service.

The disclosure relates in some aspects to a network providing, in unicast or broadcast, one or more of a per-service indication, a per-domain indication, a per-application indication, or a per-class indication to devices (e.g., specific devices, specific domains, sets of subscriptions, device classes, or application classes). The devices apply the indication to existing policies, and either block the traffic for certain applications, services, domains, etc., according to the current policies or steer the traffic to a preferred access indicated in the indication independently of what current policies exist in the device state.

In some aspects, policies in a device such as a UE are enhanced to deal with network and mission-critical issues through the use of an Application Blocking Indication (ABI) and enhancements to an access network discovery selection function (ANDSF). In some aspects, an ABI may carry a congestion indication 106. In some aspects, an ABI may carry a traffic routing policy 104. In some aspects, ANDSF rules used by a UE are based on a traffic routing policy 104 and apply a congestion indication 106 to determine whether and/or how to control traffic.

### Application Blocking Indication (ABI)

The network can send an ABI to one or more wireless communication devices via, for example, unicast signaling or broadcast signaling. In some implementations, the network sends an ABI in layer 2 signaling (e.g., via radio resource control (RRC) messages, system information blocks (SIBs), or other signaling) or over Internet protocol (IP) (e.g., via an upper layer application). The network can send an ABI over a single radio technology or over multiple radio technologies (e.g., via one or more of 3G, 4G, 5G, Wi-Fi, or millimeter wave (mmW) technology) in various implementations. For unicast distribution, the network can send the indication to a specific device by sending the indication (via RAT specific mechanisms) to all the radio technologies the device is reachable or pageable over.

As indicated above, an ABI can be sent over Wi-Fi. For example, an access point can send an ABI in a Wi-Fi beacon (e.g., sent in a broadcast for multiple wireless communication devices). As another example, in access node query protocol (ANQP) elements, a device can obtain the ABI when the device performs an ANQP query to an access point or when it listens to ANQP responses from other devices.

In some scenarios, a device can determine whether to connect to a particular network (e.g., a network in general, a cell, or a RAT) based on the network's broadcast messages, unicast messages, or responses to queries (e.g., an ANQP query or some other type of query for another type of RAT). For example, if a device is able to choose a network from multiple available networks, the device can choose the network that provides the best access restrictions from that device's viewpoint. Thus, if the applications on a device are less likely to be blocked on one network versus another network, the device can decide which network to select based on the respective blocking rules of the networks. Similarly, a device running mission-critical applications may elect to select a network that protects these applications (e.g., by blocking other applications).

An ABI can be associated with an indication of wireless communication device class. For example, an ABI can use the current classification of wireless communication devices in 3GPP or an ABI can use a newly defined set of device classes, subscription classes (e.g., silver, gold, platinum), or application classes. A device may be aware of its associated classes (e.g., device, subscriber, or application) and thus may use any indications associated with its own class, when the ABI specifies or is otherwise associated with one or more classes. For example, a device designated as class silver may take action based on ABIs associated with class silver, but not ABIs associated with class gold or class platinum.

### Access Network Discovery Selection Function (ANDSF)

ANDSF provides policies (e.g., in the form of rules) for traffic routing between 3GPP and non-3GPP accesses. ANDSF also allows the definition of policies to bar the use of a certain access for a specific traffic. For example, based on a set of time conditions and/or location conditions, traffic X cannot be carried over Wi-Fi. ANDSF identifies traffic based on three main mechanisms: (1) Application: uses an AppID to identify which application is generating traffic; (2) Destination realm: realm towards which traffic is directed; and (3) Traffic type: typically identified by source and destination addresses, source and destination port numbers, IP protocol type, etc. ANDSF thus enables certain traffic to be stopped on certain accesses under certain conditions (time, location). However, conventional ANDSF has no mechanism to consider other conditions, e.g., related to traffic congestion due to specific applications.

In accordance with the teachings herein, ANDSF is enhanced to use ABIs (e.g., policies written with ABI as a validity condition or a routing criteria) so that one or more accesses can be barred for an application (App). For example, an ANDSF MO (management object) can be extended to define rules such as: IF <condition> then {cellular|Wi-Fi|cellular/Wi-Fi) are {allowed|forbidden|limited} for {App X . . . App Y}. Condition X can be based on: A value or indicator ABI (Application Blocking Indication) that the network sends in broadcast to all devices or in unicast to a specific device (e.g., in RRC signaling).

The ABI can be a scalar so that <condition> can be defined in the form “ABI>value 1”, “ABI<value 2”, etc. As one non-limiting example, a higher ABI value may indicate that a larger number of applications are to be limited or that more severe access limitations are to be employed.

An ABI can also be a bitmap that allows the definition of more complex conditions. For example, the ABI can contain specific indications that indicate to which applications or traffic (e.g., traffic type, etc.) the ABI applies. As a particular example, ABI={AppA, AppB, AppC, TrafficType1, TrafficType2}), where TrafficType can be any of source IP address, destination IP address, port numbers, etc.

The definition of <condition> allows the definition of rules based on the identity of the application. For example, the operator can send information regarding which applications should be stopped.

Upon evaluating the validity of ANDSF rules, the device applies the latest ABI value received from the network. The UE may re-evaluate the rules periodically independently of the network broadcast or the network sending a new value in unicast. In some implementations, when evaluating the ANDSF rules, the UE can compare the ABI received from the network with the ABI that was previously used. If the ABI is different, the UE may re-evaluate the validity of the ANDSF rules (independently of whether the ABI was received in broadcast or in unicast).

If the UE receives the ABI only in broadcast, the UE may re-evaluate the rules only periodically in some implementations. If the UE receives an ABI in unicast, in some implementations, the UE may compare the ABI received from the network with the ABI that was previously used when evaluating the ANDSF rules to determine whether the ABI is different. If so, this may trigger re-evaluation of the validity of the ANDSF rules.

### Expression Pattern

Some aspects described herein relate to controlling whether an application at a wireless communication device can access a service through the use of an expression pattern that defines control criteria. That is, in some aspects, a traffic routing policy may be based on or include an expression pattern. For example, the network can define an expression pattern defining criteria for blocking an application's access to a service. An example of such a pattern is: “If [application] tries to access [IP address|port|URL] during [time] using [protocol] then [block|allow].”

The network may distribute this pattern to wireless communication devices that will, in turn, evaluate the pattern and apply the result to the transport of data (e.g., IP packets) for applications at the wireless communication devices. The pattern can be distributed in unicast in radio-layer (layer 2) or upper layer signaling, or distributed in broadcast via, for example, layer 2 mechanisms. A wireless communication device that receives such a pattern from the network can thereby monitor conditions (e.g., in real time), and take the appropriate action whenever the specified criteria is met.

### Example Implementations

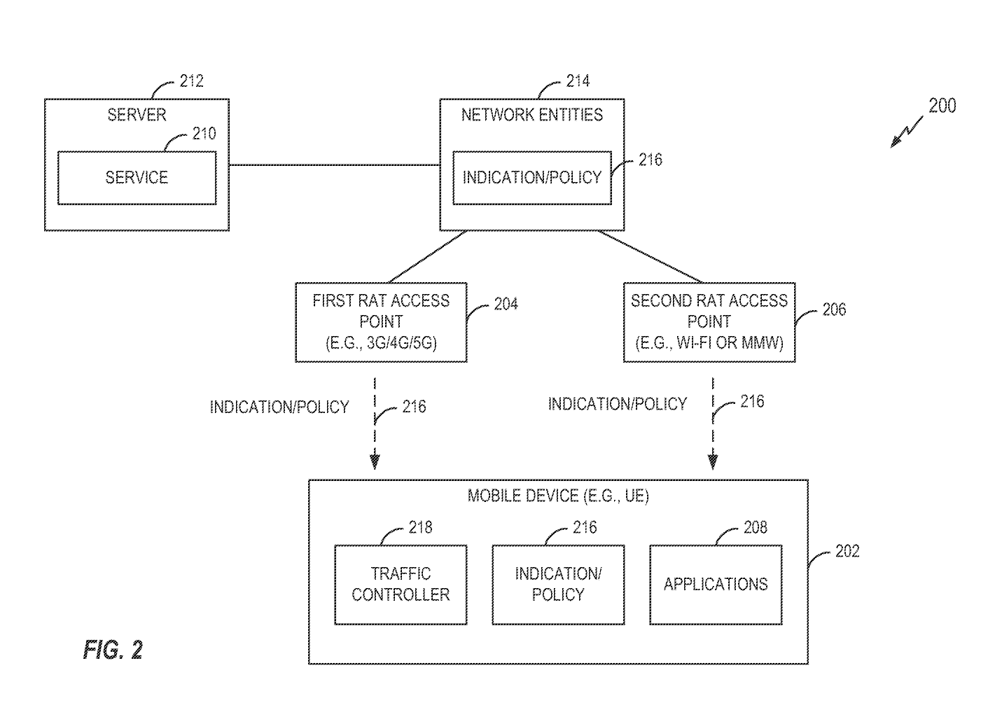

Several example implementations will now be described with reference to FIGS. 2-9. For purposes of illustration, these figures may illustrate various components in the context of LTE and Wi-Fi networks. It should be appreciated, however, that the teachings herein may be employed in other types of radio technologies and architectures. Also, to reduce the complexity of FIG. 2, only a single mobile device is shown. It should be appreciated, however, that the teaching herein can be implemented in any number of mobile devices or other types of wireless communication devices.

FIG. 2 is a simplified exemplary network system 200 where a multi-mode mobile device 202 communicates via at least a first radio access technology (RAT) and a second RAT. To this end, the mobile device 202 receives wireless service via a first RAT access point 204 and a second RAT access point 206. Other types of RATs and/or additional access points (not shown) could also be employed.

Applications 208 on the mobile device 202 access a service 210 provided by a server 212. In some aspects, the traffic for the service 210 flows between the server 212 and the mobile device 202 via at least one of the access points 204 and 206 and one or more network entities 214. As discussed herein, congestion associated with such a service may adversely affect traffic flow in the network system 200.

In accordance with the teachings herein, the network (e.g., a network entity and/or an access point) generates indications (e.g., ABIs, congestion indications, etc.) and/or policy (e.g., ANDSF rules, expression patterns, etc.), represented as indication/policy 216, that the mobile device 202 can use to control whether and/or how the applications 208 at the mobile device 202 access the service 210. As indicated, the first RAT access point 204 can send such an indication/policy 216 to the mobile device 202 and/or the second RAT access point 206 can send such an indication/policy 216 to the mobile device 202.

A traffic controller 218 of the mobile device 202 can thus use the indication/policy 216 to control traffic flow from the applications 208 to the service 210 and/or other traffic flow (e.g., mission critical traffic flow). In some aspects, the traffic controller 218 may correspond to the traffic controller 102 of FIG. 1.

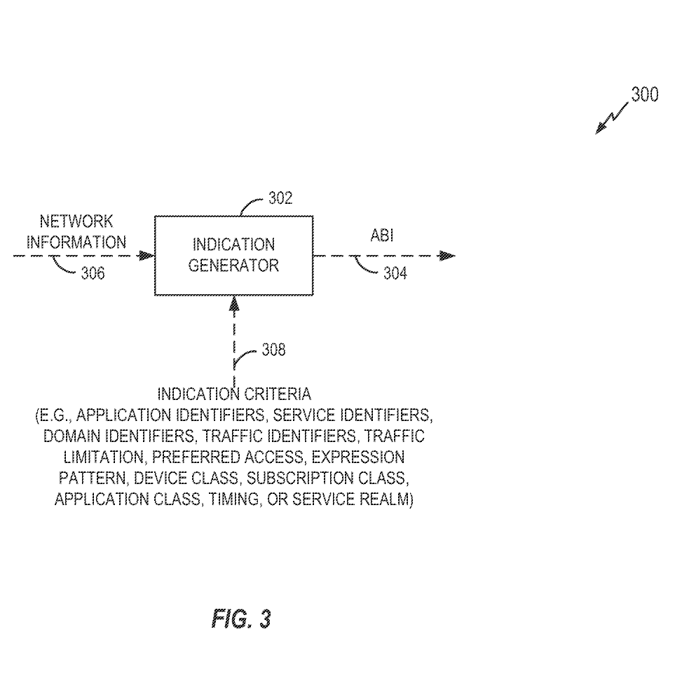

FIG. 3 illustrates an example of an apparatus 300 (e.g., a network entity or an access point) that generates an ABI. For example, the apparatus 300 may correspond to one or more of the access point 204, the access point 206, or the network entities 214 of FIG. 2. While an ABI is described here for illustration purposes, it should be appreciated that other types of indications could be generated using these or similar techniques.

An indication generator 302 generates an ABI 304 based on network information (e.g., information indicating that certain services and applications may need to be controlled) 306 and indication criteria 308. The indication criteria 308 may include information that may be included in or otherwise associated with the ABI 304. Non-limiting examples of such indication criteria 308 include an identifier of an application subject to control, an identifier of a service subject to control, an identifier of the destination domain of the traffic subject to control, an identifier of traffic (e.g., a traffic type, etc.) subject to control, a type of limitation to be placed on traffic from an application to a service, a form of preferred access for an application and/or service, an expression pattern, a device class indicating the class of device to which the ABI 304 pertains, a subscription class indicating the class of subscription (e.g., user subscriptions with an operator) to which the ABI 304 pertains, a subscription class indicating the class of subscription (e.g., user subscriptions with an operator) to which the ABI 304 pertains, an application class indicating the class of application (e.g., instant messaging (IM)) to which the ABI 304 pertains, information indicating times during which the ABI 304 is applicable, or information indicating the service realm (e.g., a service with a particular URL address, a service associated with a type of social media device, and so on) to which the ABI 304 applies.

Thus, in some aspects, the network can provide to devices information to limit (e.g., block) traffic from specific applications. This may involve, for example, completely blocking the traffic generated by the applications in a UE. Alternatively, this may involve, for example, banning a specific access for traffic generated by the applications in the UE.

In particular, the network can provision devices with an indication of traffic restrictions. This indication may be service specific, application specific, domain specific (e.g. a URL), etc. This indication may be a tuple, e.g., <Traffic type/Application ID, information>. This indication may be an expression pattern defining, for example, blocking criteria. The indication may be sent upon request from the UE. Traffic restrictions may indicate a preferred access for specific traffic. The indication can be associated with an indication of mobile device class subscription classes (e.g., silver, gold, platinum), e.g., reusing the current classification of mobile devices in 3GPP or defining a new set of device classes.

The indication may be sent in broadcast or unicast to devices. For unicast distribution, the network can send the indication to a specific device by sending the indication (e.g., via RAT specific mechanisms) to all the radio technologies the devices is reachable or pageable over. The indication can be sent in layer 2 signaling (e.g., RRC, SIBs, etc.), via non-access stratum (NAS) signaling, over IP, or in some other manner. The indication can be sent by the network over a single radio technology or over multiple radio technologies.

Also, in some aspects, the network can provision devices with traffic routing policies that contain the indication from the network. As discussed herein, the indication can be used, for example, as validity conditions for rules or traffic routing conditions, etc.

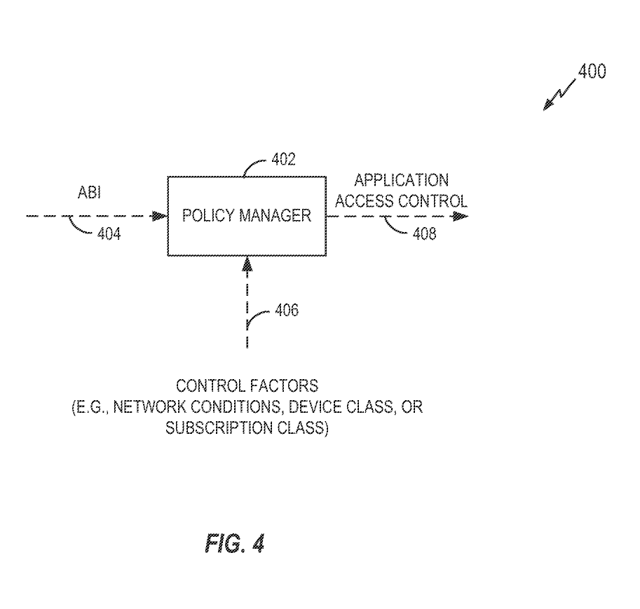

FIG. 4 illustrates an exemplary apparatus 400 (e.g., a mobile device) that controls application access based on a received ABI. For example, the apparatus 400 may correspond to the mobile device 202 of FIG. 2. While an ABI is again described here for illustration purposes, it should be appreciated that other types of indications could be used to control access as taught herein.

A policy manager 402 applies a received ABI 404 to a traffic routing policy (e.g., ANDSF rules) that the apparatus 400 uses to control whether and/or how the applications at the apparatus 400 access a given service. In some implementations, the policy manager 402 corresponds to the traffic controller 218 of FIG. 2. The traffic routing policy takes into account one or more control factors 406. For example, in some scenarios, application access control (e.g., blocking) 408 is invoked if certain network conditions exist (e.g., congestion is present). Also, in some scenarios, the policy may only apply the access control specified in the ABI 404 if a class (e.g., device class, subscription class, or application class) indicated in the ABI 404 matches a class associated with the apparatus 400.

Thus, in some aspects, a mobile device (e.g., a UE) can receive an indication from the network and apply policies to determine if traffic generated by specific applications at the mobile device can be transmitted or not. If the received indication contains an indication of preferred access for specific traffic, the indication overrides the policies (e.g., ANDSF) in the mobile device. That is, the access selected for the specific traffic is the one specified in the received indication.

If the indication is associated with one or more of a device class, a subscription class, or an application class, the mobile device verifies whether the mobile device belongs to the class or classes and applies the received indication if there is a match.

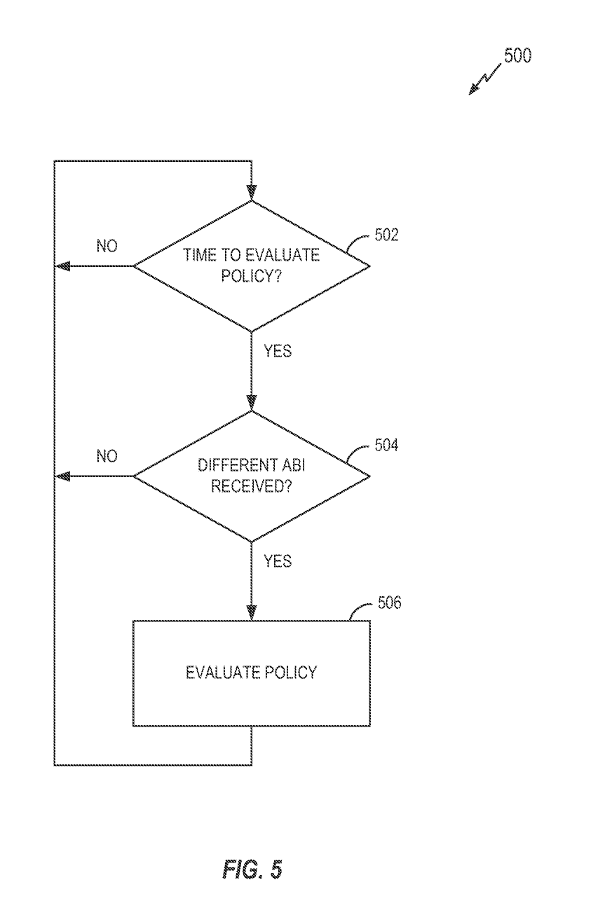

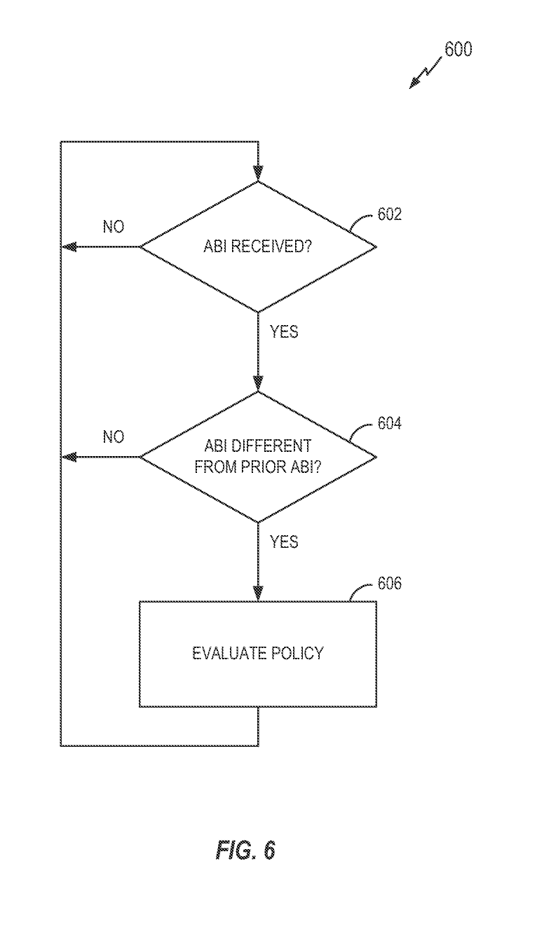

In general, a wireless communication device applies the latest ABI value received from the network. The device may re-evaluate its policy (e.g., ANDSF rules) periodically independently of the network broadcasting a new value or sending a new value in unicast. FIGS. 5 and 6 illustrate examples of a process 500 and a process 600, respectively, (e.g., implemented at a mobile device) for evaluating policy. For example, the process 500 or the process 600 may be executed by the traffic controller 218 of the mobile device 202 of FIG. 2. In either case, the device may trigger the policy re-evaluation by comparing the indication (e.g., ABI) received from the network with the indication that was previously used. If the received indication is different, the device re-evaluates the validity of the policy (e.g., ANDSF rules) independently of whether the indication was received in broadcast or in unicast.

Referring initially to FIG. 5, in some scenarios, the device re-evaluates the policy at certain times. In some implementations, a device periodically (e.g., at a designated evaluation time) re-evaluates the policy. For example, this form of re-evaluation may be invoked if the device receives an indication (e.g., an ABI) in broadcast. Accordingly, at block 502, the device determines whether it is now time to evaluate the policy.

The device then compares the indication received from the network with the indication that was previously used. For example, at block 504, the device determines whether a different ABI has been received (i.e., different from a previously received ABI).

At block 506, if the indication is different, the device re-evaluates the policy. For example, the device will re-evaluate the validity of the ANDSF rules in some implementations.

Referring to FIG. 6, in some scenarios, a device re-evaluates its policy (e.g., ANDSF rules) upon receipt of an indication (e.g., an ABI). At block 602, the device checks to see whether it has received an indication. This form of re-evaluation may be invoked, for example, if the device receives the indication in unicast. At block 604, the mobile device compares the indication received from the network with the indication that was previously used. At block 606, if the indication is different, the device re-evaluates the validity of the policy.

The operations of FIGS. 5 and 6 could be combined. For example, re-evaluation could be triggered by receipt of an indication (e.g., as in FIG. 6) and at designated evaluation times (e.g., as in FIG. 5).

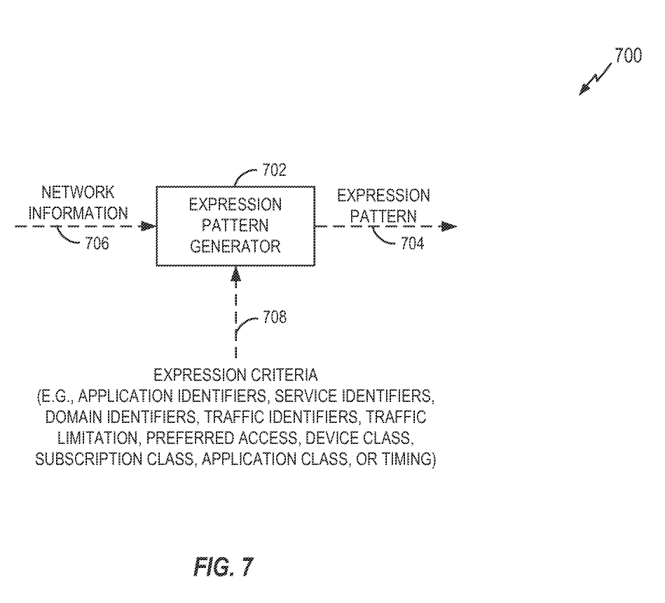

FIG. 7 illustrates an exemplary apparatus 700 (e.g., a network entity or an access point) that generates an expression pattern. For example, the apparatus 700 may correspond to one or more of the access point 204, the access point 206, or the network entities 214 of FIG. 2. While an expression pattern is described here for illustration purposes, it should be appreciated that other types of expressions could be generated using these or similar techniques.

An expression pattern generator 702 generates an expression pattern 704 based on network information (e.g., information indicating that certain services and applications may need to be controlled) 706 and expression criteria 708. The expression criteria 708 may include information that may be included in or otherwise associated with the expression pattern 704. Non-limiting examples of such expression criteria 708 include an identifier of an application subject to control, an identifier of a service subject to control, an identifier of the destination domain of the traffic subject to control, an identifier of traffic (e.g., a traffic type, etc.) subject to control, a type of limitation to be place on traffic from an application to a service, a form of preferred access for an application and/or service, a device class indicating the class of device to which the expression pattern 704 pertains, a subscription class indicating the class of subscription (e.g., user subscriptions with an operator) to which the expression pattern 704 pertains, an application class indicating the class of application (e.g., IM) to which the expression pattern 704 pertains, or information indicating times during which the expression pattern 704 is applicable.

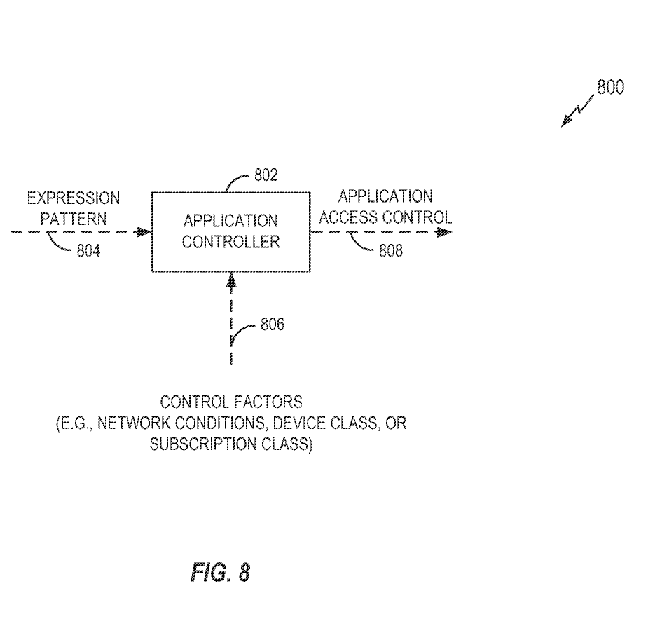

FIG. 8 illustrates an exemplary apparatus 800 (e.g., a mobile device) that controls application access based on a received expression pattern. For example, the apparatus 800 may correspond to the mobile device 202 of FIG. 2. While an expression pattern is again described here for illustration purposes, it should be appreciated that other types of expressions could be used to control access as taught herein.

An application controller 802 uses a received expression pattern 804 to control whether and/or how the applications at the apparatus 800 access a given service. In some implementations, the application controller 802 corresponds to the traffic controller 218 of FIG. 2. The application controller 802 also takes into account one or more control factors 806. For example, in some scenarios, application access control (e.g., blocking) 808 is invoked if certain network conditions exist (e.g., congestion is present). Also, in some scenarios, the policy may only apply the access control specified in the expression pattern 804 if a class (e.g., device class, subscription class, or application class) indicated in the expression pattern 804 matches a class associated with the apparatus 800.

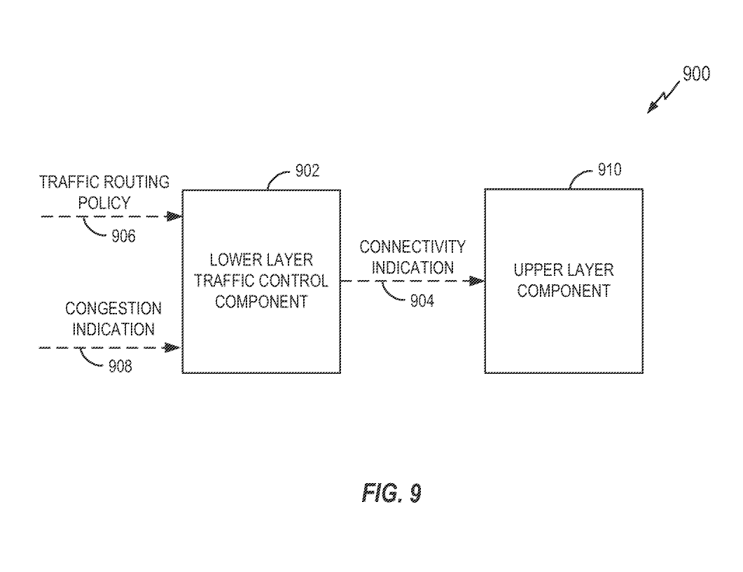

FIG. 9 illustrates an exemplary an apparatus 900 (e.g., a mobile device) where a lower layer protocol layer (e.g., layer 2 or 3) of the apparatus 900 provides indications to the upper protocols layers (users or applications) to indicate that connectivity for specific applications is not available. The apparatus 900 may correspond to the mobile device 202 of FIG. 2.

A lower layer traffic control component 902 generates such a connectivity indication 904 based on received traffic routing policy 906 and received congestion indication 908. For example, if the traffic routing policy 906 states that traffic from a particular application is to be blocked if there is congestion at a particular server, and if the congestion indication indicates that there is congestion at that server, the lower layer traffic control component 902 sends a connectivity indication 904 to an upper layer component 910 to inform the upper layer component 910 that this particular application cannot establish connectivity with the server at this time. The upper layer component 910 may then block the application. In addition, in some implementations, the upper layer component 910 may inform a user of the apparatus 900 that the application is blocked.

### Exemplary Electronic Device

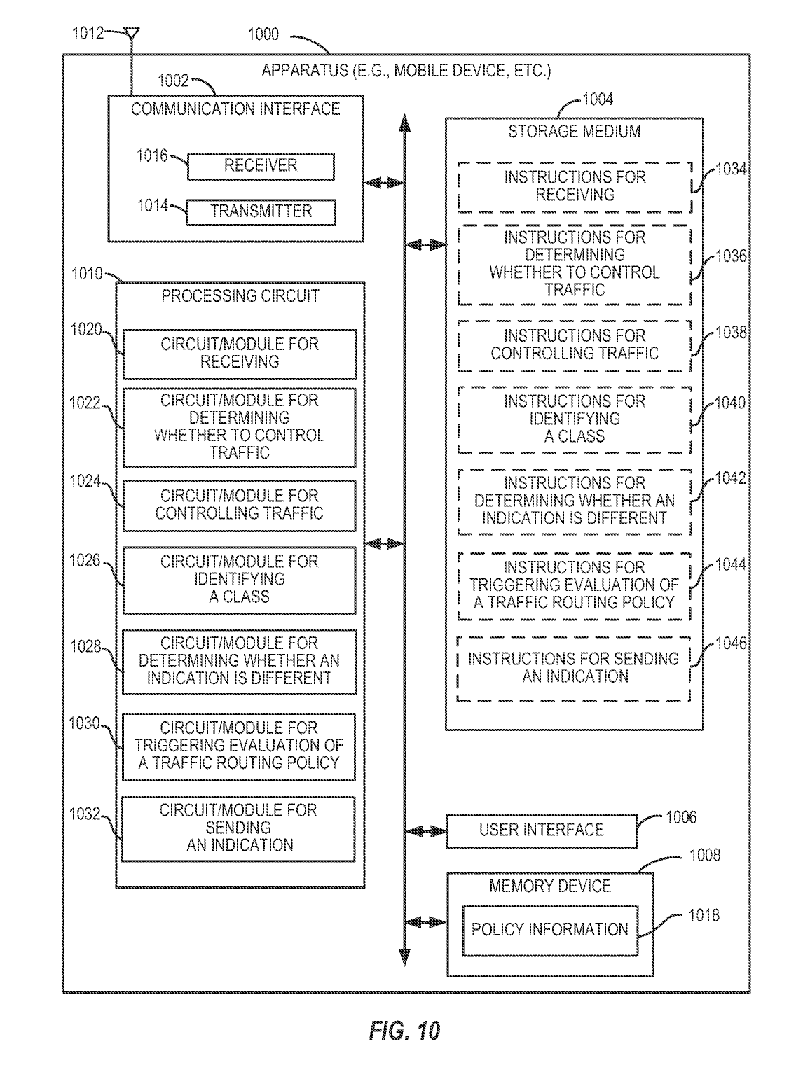

FIG. 10 illustrates a block diagram of an exemplary hardware implementation of an apparatus 1000 configured to control application traffic according to one or more aspects. For example, the apparatus 1000 could embody a mobile device (e.g., the mobile device 202 of FIG. 2), a network node (e.g., the network entities 214 of FIG. 2), an access point (e.g., the access point 204 or the access point 206 of FIG. 2), or some other type of device. In various implementations, the apparatus 1000 could be a mobile phone, a smart phone, a tablet, a portable computer, a server, a personal computer, and or any other electronic device having circuitry.

The apparatus 1000 includes a communication interface (e.g., at least one transceiver) 1002, a storage medium 1004, a user interface 1006, a memory device (e.g., a memory circuit) 1008, and a processing circuit (e.g., at least one processor) 1010. In various implementations, the user interface 1006 may include one or more of: a keypad, a display, a speaker, a microphone, a touchscreen display, of some other circuitry for receiving an input from or sending an output to a user.

These components can be coupled to and/or placed in electrical communication with one another via a signaling bus or other suitable component, represented generally by the connection lines in FIG. 10. The signaling bus may include any number of interconnecting buses and bridges depending on the specific application of the processing circuit 1010 and the overall design constraints. The signaling bus links together various circuits such that each of the communication interface 1002, the storage medium 1004, the user interface 1006, and the memory device 1008 are coupled to and/or in electrical communication with the processing circuit 1010. The signaling bus may also link various other circuits (not shown) such as timing sources, peripherals, voltage regulators, and power management circuits, which are well known in the art, and therefore, will not be described any further.

The communication interface 1002 provides a means for communicating with other apparatuses over a transmission medium. In some implementations, the communication interface 1002 includes circuitry and/or programming adapted to facilitate the communication of information bi-directionally with respect to one or more communication devices in a network. In some implementations, the communication interface 1002 is adapted to facilitate wireless communication of the apparatus 1000. In these implementations, the communication interface 1002 may be coupled to one or more antennas 1012 as shown in FIG. 10 for wireless communication within a wireless communication system. The communication interface 1002 can be configured with one or more standalone receivers and/or transmitters, as well as one or more transceivers. In the illustrated example, the communication interface 1002 includes a transmitter 1014 and a receiver 1016. The communication interface 1002 serves as one example of a means for receiving and/or means transmitting.

The memory device 1008 may represent one or more memory devices. As indicated, the memory device 1008 may maintain policy information 1018 along with other information used by the apparatus 1000. In some implementations, the memory device 1008 and the storage medium 1004 are implemented as a common memory component. The memory device 1008 may also be used for storing data that is manipulated by the processing circuit 1010 or some other component of the apparatus 1000.

The storage medium 1004 may represent one or more computer-readable, machine-readable, and/or processor-readable devices for storing programming, such as processor executable code or instructions (e.g., software, firmware), electronic data, databases, or other digital information. The storage medium 1004 may also be used for storing data that is manipulated by the processing circuit 1010 when executing programming. The storage medium 1004 may be any available media that can be accessed by a general purpose or special purpose processor, including portable or fixed storage devices, optical storage devices, and various other mediums capable of storing, containing or carrying programming.

By way of example and not limitation, the storage medium 1004 may include a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The storage medium 1004 may be embodied in an article of manufacture (e.g., a computer program product). By way of example, a computer program product may include a computer-readable medium in packaging materials. In view of the above, in some implementations, the storage medium 1004 may be a non-transitory (e.g., tangible) storage medium.

The storage medium 1004 may be coupled to the processing circuit 1010 such that the processing circuit 1010 can read information from, and write information to, the storage medium 1004. That is, the storage medium 1004 can be coupled to the processing circuit 1010 so that the storage medium 1004 is at least accessible by the processing circuit 1010, including examples where at least one storage medium is integral to the processing circuit 1010 and/or examples where at least one storage medium is separate from the processing circuit 1010 (e.g., resident in the apparatus 1000, external to the apparatus 1000, distributed across multiple entities, etc.).

Programming stored by the storage medium 1004, when executed by the processing circuit 1010, causes the processing circuit 1010 to perform one or more of the various functions and/or process operations described herein. For example, the storage medium 1004 may include operations configured for regulating operations at one or more hardware blocks of the processing circuit 1010, as well as to utilize the communication interface 1002 for wireless communication utilizing their respective communication protocols.

The processing circuit 1010 is generally adapted for processing, including the execution of such programming stored on the storage medium 1004. As used herein, the term “programming” shall be construed broadly to include without limitation instructions, instruction sets, data, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The processing circuit 1010 is arranged to obtain, process and/or send data, control data access and storage, issue commands, and control other desired operations. The processing circuit 1010 may include circuitry configured to implement desired programming provided by appropriate media in at least one example. For example, the processing circuit 1010 may be implemented as one or more processors, one or more controllers, and/or other structure configured to execute executable programming. Examples of the processing circuit 1010 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 1010 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 1010 are for illustration and other suitable configurations within the scope of the disclosure are also contemplated.

According to one or more aspects, the processing circuit 1010 may be adapted to perform any or all of the features, processes, functions, operations and/or routines for any or all of the apparatuses described herein. For example, the processing circuit 1010 may be configured to perform any of the steps, functions, and/or processes described with respect to FIGS. 1-9 and 11-21. As used herein, the term “adapted” in relation to the processing circuit 1010 may refer to the processing circuit 1010 being one or more of configured, employed, implemented, and/or programmed to perform a particular process, function, operation and/or routine according to various features described herein.

The processing circuit 1010 may be a specialized processor, such as an application specific integrated circuit (ASIC) that serves as a means for (e.g., structure for) carrying out any one of the operations described in FIGS. 1-9 and 11-21. The processing circuit 1010 serves as one example of a means for receiving, a means for determining whether to control traffic, a means for controlling traffic, a means for identifying a class, a means for determining whether an indication is different, a means for triggering evaluation of a traffic routing policy, or a means for sending an indication. The processing circuit 1010 also serves as one example of a means for receiving and/or transmitting.

According to at least one example of the apparatus 1000, the processing circuit 1010 may include one or more of a circuit/module for receiving 1020, a circuit/module for determining whether to control traffic 1022, a circuit/module for controlling traffic 1024, a circuit/module for identifying a class 1026, a circuit/module for determining whether an indication is different 1028, a circuit/module for triggering evaluation of a traffic routing policy 1030, or a circuit/module for sending an indication 1032.

The circuit/module for receiving 1020 may include circuitry and/or programming (e.g., instructions for receiving 1034 stored on the storage medium 1004) adapted to perform several functions relating to, for example, receiving a traffic routing policy, receiving an indication of congestion at a server, or other information in the form of an electrical signal. Initially, the circuit/module for receiving 1020 obtains received information. For example, the circuit/module for receiving 1020 may obtain this data directly from a component of the apparatus (e.g., the receiver 1016, the memory device 1008, or some other component). In some implementations, the circuit/module for receiving 1020 identifies a memory location in the memory device 1008 and invokes a read of that location to receive information. In some implementations, the circuit/module for receiving 1020 processes the received information. The circuit/module for receiving 1020 then outputs the received information (e.g., stores the information in the memory device 1008 or sends the information to another component of the apparatus 1000).

The circuit/module for determining whether to control traffic 1022 may include circuitry and/or programming (e.g., instructions for determining whether to control traffic 1036 stored on the storage medium 1004) adapted to perform several functions relating to, for example, determining whether to control traffic based on a traffic routing policy and an indication of congestion. Initially, the traffic routing policy and the indication of congestion are obtained (e.g., retrieved from the memory device 1008 or received another component of the apparatus 1000). In some implementations, the circuit/module for determining whether to control traffic 1022 uses the indication of congestion as an input to the traffic routing policy (e.g., a rule or expression where the indication is an input to the rule or expression) to obtain an indication of whether traffic should be controlled (e.g., blocked). The circuit/module for determining whether to control traffic 1022 may then output the indication (e.g., store the indication in the memory device 1008 or send the indication to another component of the apparatus 1000).

The circuit/module for controlling traffic 1024 may include circuitry and/or programming (e.g., instructions for controlling traffic 1038 stored on the storage medium 1004) adapted to perform several functions relating to, for example, control traffic as a result of the determination of the circuit/module for determining whether to control traffic 1022. Initially, the circuit/module for controlling traffic 1024 receives an indication of the determination of the circuit/module for determining whether to control traffic 1022 (e.g., directly or from the memory device 1008). If the indication indicates that traffic is to be controlled, the circuit/module for controlling traffic 1024 controls traffic in a designated manner. The manner of controlling traffic can take different forms in different scenarios. In some scenarios, controlling traffic involves limiting traffic flow from an application to a server. For example, traffic may be completely blocked. In some scenarios, controlling traffic involves controlling the flow of an indicated traffic from an application to a server. In this case, certain traffic may be controlled (e.g., blocked) while other traffic is not. In some scenarios, controlling traffic involves routing particular traffic according to an indicated preferred access. For example, traffic for mission-critical applications may be left unblocked while traffic for non-mission-critical applications is blocked. In some implementations, the circuit/module for controlling traffic 1024 sends an indication (e.g., stores the indication in the memory device 1008 or sends the indication to another component of the apparatus 1000) to an upper protocol layer that will then control traffic (e.g., stop an application from sending traffic) according to the indication. In some implementations, the circuit/module for controlling traffic 1024 includes an upper protocol layer that can control application behavior.

The circuit/module for identifying a class 1026 may include circuitry and/or programming (e.g., instructions for identifying a class 1040 stored on the storage medium 1004) adapted to perform several functions relating to, for example, identifying a class associated with a wireless communication device. Initially, the circuit/module for identifying a class 1026 determines where information indicative of the class is located (e.g., in the memory device 1008 or at another component of the apparatus 1000). The circuit/module for identifying a class 1026 then retrieves this information and determines the class indicated by this information. In some scenarios, the class is a device class. In some scenarios, the class is a subscription class. In some scenarios, the class is an application class. The circuit/module for identifying a class 1026 may then output an indication of the identified class (e.g., store the indication in the memory device 1008 or send the indication to another component of the apparatus 1000).

The circuit/module for determining whether an indication is different 1028 may include circuitry and/or programming (e.g., instructions for determining whether an indication is different 1042 stored on the storage medium 1004) adapted to perform several functions relating to, for example, determining whether an indication of congestion is different from a previously received indication of congestion. Initially, the circuit/module for determining whether an indication is different 1028 obtains the two indications (e.g., from the memory device 1008 or another component of the apparatus 1000). The circuit/module for determining whether an indication is different 1028 compares the two indications. The circuit/module for determining whether an indication is different 1028 then outputs an indication of the results (e.g., equal or not equal) of the comparison (e.g., stores the indication in the memory device 1008 or sends the indication to another component of the apparatus 1000).

The circuit/module for triggering evaluation of a traffic routing policy 1030 may include circuitry and/or programming (e.g., instructions for triggering evaluation of a traffic routing policy 1044 stored on the storage medium 1004) adapted to perform several functions relating to, for example, triggering evaluation of a traffic routing policy based on the determination of the circuit/module for determining whether an indication is different 1028. Initially, the circuit/module for triggering evaluation of a traffic routing policy 1030 receives an indication of the determination of the circuit/module for determining whether an indication is different 1028 (e.g., directly or from the memory device 1008). If the indication indicates that a newer indication of congestion is different from an older indication of congestion, the circuit/module for triggering evaluation of a traffic routing policy 1030 invokes evaluation of the traffic routing policy. In some implementations, the circuit/module for triggering evaluation of a traffic routing policy 1030 passes the new indication of congestion to the circuit/module for determining whether to control traffic 1022, and invokes the operations of the circuit/module for determining whether to control traffic 1022 to determine whether the current traffic routing (e.g., blocked or not blocked) should be changed.

The circuit/module for sending an indication 1032 may include circuitry and/or programming (e.g., instructions for sending an indication 1046 stored on the storage medium 1004) adapted to perform several functions relating to, for example, sending an indication to an upper protocol layer indicating that connectivity for a particular application is not available. Initially, the circuit/module for sending an indication 1032 receives an indication of the determination of the circuit/module for determining whether to control traffic 1022 (e.g., directly or from the memory device 1008). In some implementations, if the indication indicates that traffic for a given application is blocked, the circuit/module for sending an indication 1032 sends another indication to an upper protocol layer indicating that connectivity for a particular application is not available (e.g., by passing the indication via the memory device 1008).

As mentioned above, programming/instructions stored by the storage medium 1004, when executed by the processing circuit 1010, causes the processing circuit 1010 to perform one or more of the various functions and/or process operations described herein. For example, the programming, when executed by the processing circuit 1010, may cause the processing circuit 1010 to perform the various functions, steps, and/or processes described herein with respect to FIGS. 1-9 and 11-21 in various implementations. As shown in FIG. 10, the storage medium 1004 may include one or more of the instructions for receiving 1034, the instructions for determining whether to control traffic 1036, the instructions for controlling traffic 1038, the instructions for identifying a class 1040, the instructions for determining whether an indication is different 1042, the instructions for triggering evaluation of a traffic routing policy 1044, or the instructions for sending an indication 1046.

### Exemplary Processes for Traffic Control

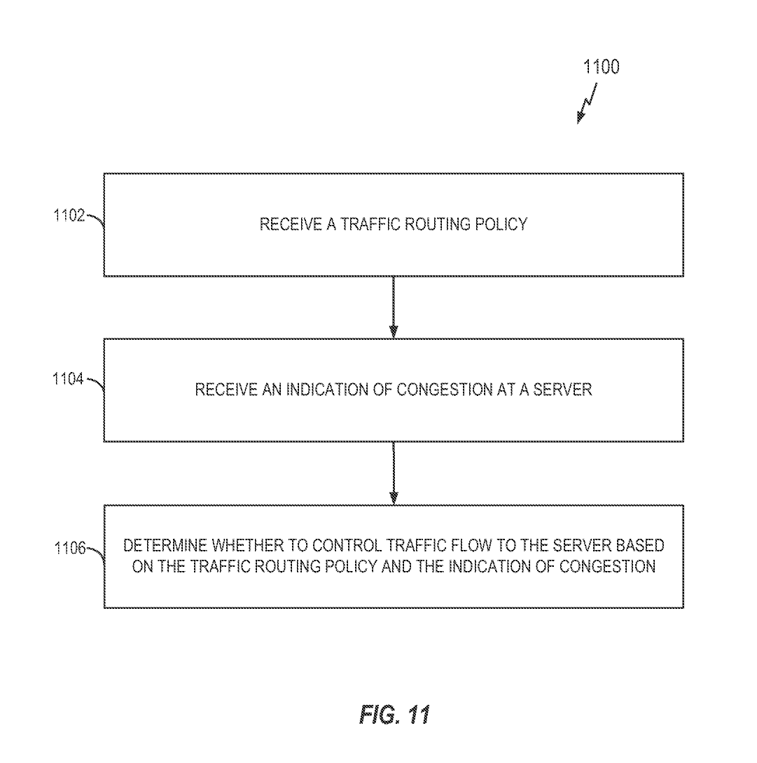

FIG. 11 illustrates a process 1100 for controlling traffic in accordance with some aspects. The process 1100 may take place within a processing circuit (e.g., the processing circuit 1010 of FIG. 10), which may be located in a mobile device, or some other suitable apparatus. Of course, in various aspects within the scope of the disclosure, the process 1100 may be implemented by any suitable apparatus capable of supporting traffic control operations.

At block 1102, a traffic routing policy is received. For example, a UE may receive this traffic routing policy via broadcast signaling or unicast signaling.

In some aspects, the traffic routing policy includes at least one of: an application identifier, a service identifier, or a domain identifier. Thus, a particular policy (e.g., when to block traffic) might only apply to one or more of: a particular application, a particular service, or a particular domain. In some aspects, a domain identifier enables identification of traffic from one or more applications that is directed to a particular domain. As one example, a domain identifier may be used to identity traffic directed to Netflix.com or some other domain. In some implementation, the domain identifier is in the form of a universal resource locator (URL).

In some aspects, the traffic routing policy includes an expression pattern defining at least one traffic control criterion. As a non-limiting example, the traffic routing policy may take the form of “if [application] tries to access [IP address|port|URL] during [time] using [protocol] then [block|allow]” in some cases.

At block 1104, an indication of congestion at a server is received. For example, a UE may receive this indication from the network via broadcast signaling or unicast signaling.

At block 1106, a determination is made as to whether to control traffic flow to the server. This determination is based on the traffic routing policy received at block 1102 and the indication of congestion received at block 1104. For example, the traffic routing policy may specify congestion at a particular server as a trigger condition for blocking traffic and the indication may specify whether there is congestion at that server.

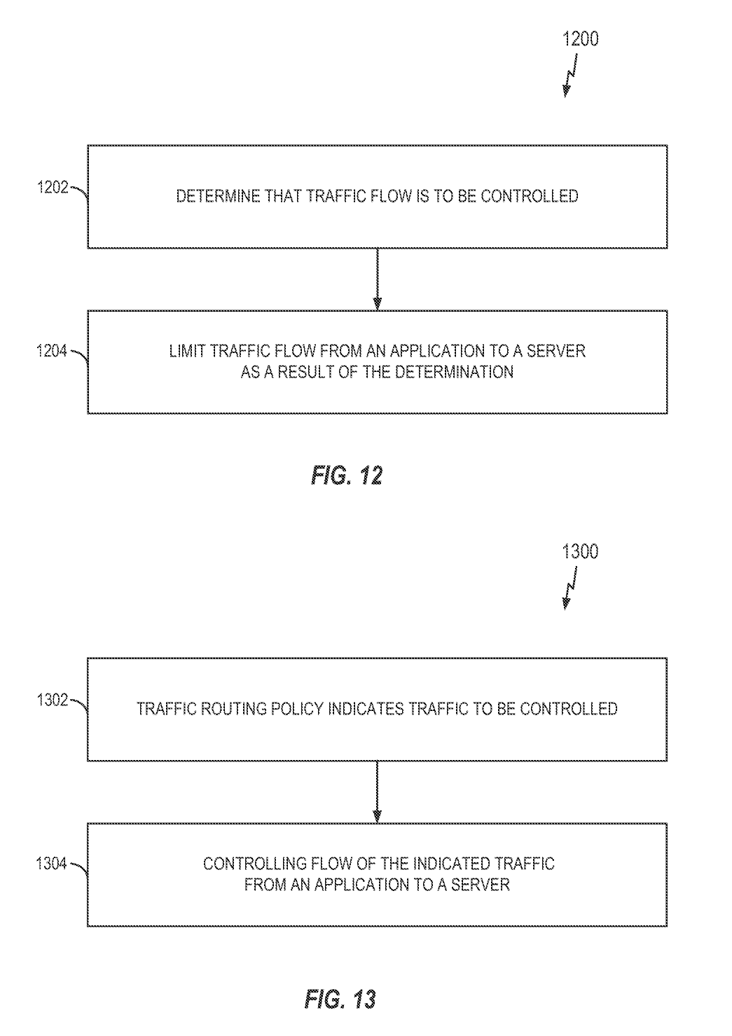

Referring to FIG. 12, in some aspects, controlling traffic flow includes limiting traffic flow from an application to a server. FIG. 12 illustrates a process 1200 for limiting traffic flow in accordance with some aspects. The process 1200 may be performed in conjunction with the process 1100 of FIG. 11. The process 1200 may take place within a processing circuit (e.g., the processing circuit 1010 of FIG. 10), which may be located in a mobile device, or some other suitable apparatus. Of course, in various aspects within the scope of the disclosure, the process 1200 may be implemented by any suitable apparatus capable of supporting traffic control operations.

At block 1202, a determination is made that traffic flow is to be controlled. For example, the operations of block 1202 may correspond to the operations of block 1106 of FIG. 11.

At block 1204, traffic flow from an application to a server is limited as a result of the determination of block 1202. For example, this traffic flow may be limited if there is congestion at the server and the application accesses services provided by the server. In some aspects, the limiting of traffic flow includes completely blocking the traffic flow or blocking a specific access by the application.

Referring to FIG. 13, in some aspects, the traffic routing policy may indicate traffic to be controlled. FIG. 13 illustrates a process 1300 for controlling traffic based on a traffic designation in accordance with some aspects. The process 1300 may be performed in conjunction with the process 1100 of FIG. 11. The process 1300 may take place within a processing circuit (e.g., the processing circuit 1010 of FIG. 10), which may be located in a mobile device, or some other suitable apparatus. Of course, in various aspects within the scope of the disclosure, the process 1300 may be implemented by any suitable apparatus capable of supporting traffic control operations.

At block 1302, the traffic routing policy indicates traffic to be controlled. In some aspects, the indicated traffic may correspond to a traffic type. Non-limiting examples of traffic types include instant messaging (IM) traffic, streaming traffic, best-effort traffic, web-traffic, user datagram protocol (UDP) traffic, and so on. In some cases, a traffic type is indicated by a specific port number, address, or some other identifier. In some aspects, the indicated traffic may correspond to traffic identified in other ways. For example, the indicated traffic may correspond to traffic to a specific destination, traffic from a specific source, traffic associated with (e.g., belonging to) a specific application or set of applications, and so on.

At block 1304, flow of the indicated traffic (e.g., traffic type, etc.) from an application to a server is controlled. For example, a UE may block the indicated traffic from being sent from the UE but allow other traffic (e.g., other traffic types, etc.) to be sent from the UE. Alternatively, the UE may allow the indicated traffic to be sent from the UE but block other traffic.

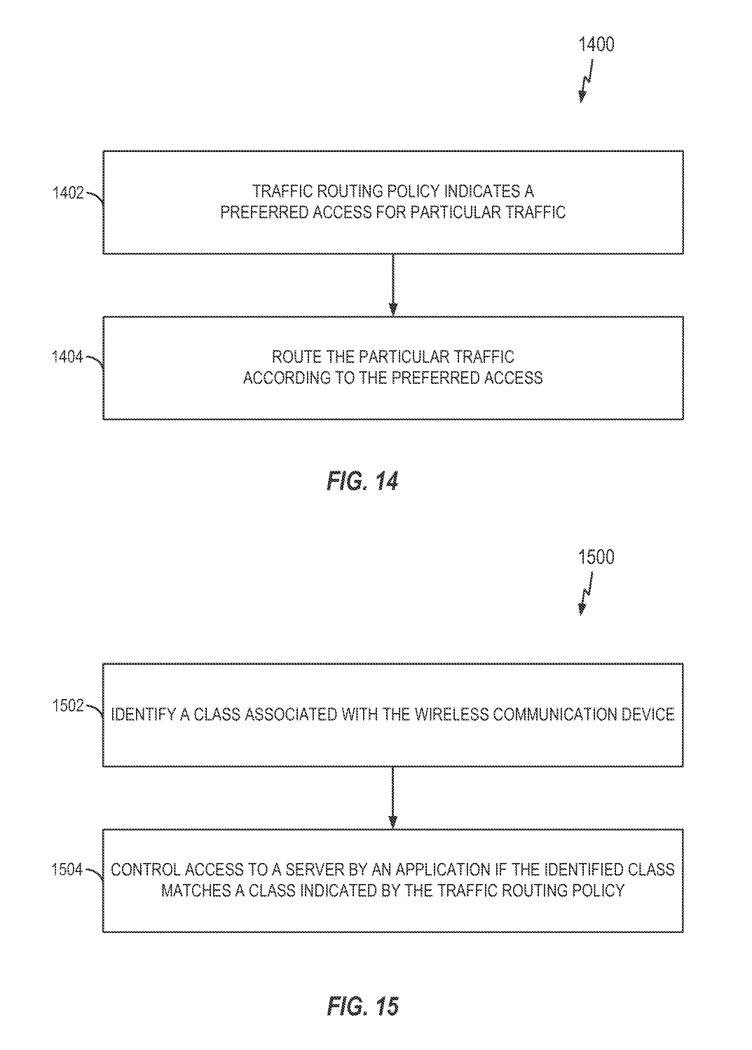

Referring to FIG. 14, in some aspects, the traffic routing policy may indicate a preferred access for particular traffic. FIG. 14 illustrates a process 1400 for controlling traffic based on preferred access in accordance with some aspects. The process 1400 may be performed in conjunction with the process 1100 of FIG. 11. The process 1400 may take place within a processing circuit (e.g., the processing circuit 1010 of FIG. 10), which may be located in a mobile device, or some other suitable apparatus. Of course, in various aspects within the scope of the disclosure, the process 1400 may be implemented by any suitable apparatus capable of supporting traffic control operations.

At block 1402, the traffic routing policy indicates a preferred access for particular traffic. For example, traffic for mission-critical applications may be designated as not to be blocked. As discussed above in conjunction with FIG. 13, the particular traffic may relate to a particular traffic type, or traffic identified in other ways (e.g., based on associated source, destination, application(s), etc.).

At block 1404, the particular traffic is routed according to the preferred access. In some aspects, the indicated preferred access overrides a corresponding traffic routing policy previously configured at a wireless communication device. For example, even if congestion at a corresponding server is indicated, the UE may still allow a mission-critical application to send traffic to the server. Moreover, the UE may block other traffic (e.g., irrespective of whether there is congestion) to provide sufficient quality of service for the mission-critical application.

Referring to FIG. 15, in some aspects, the traffic routing policy indicates a class to which the policy is applicable. FIG. 15 illustrates a process 1500 for controlling traffic based on a class designation in accordance with some aspects. The process 1500 may be performed in conjunction with the process 1100 of FIG. 11. The process 1500 may take place within a processing circuit (e.g., the processing circuit 1010 of FIG. 10), which may be located in a mobile device, or some other suitable apparatus. Of course, in various aspects within the scope of the disclosure, the process 1500 may be implemented by any suitable apparatus capable of supporting traffic control operations.

At block 1502, a class associated with a wireless communication device is identified. In some aspects, the identified class relates to at least one of: a device class, a subscription class, or an application class. For example, devices in a wireless system may be designated at “silver” devices, “gold” devices, or “platinum” devices indicative of the service to which the device is entitled. As another example, users may subscribe to different services. Accordingly, the devices used by these users may be associated with different subscription classes indicative of, for example, the services that the device is entitled to access. As yet another example, applications may be aggregated into classes where, for example, different application classes are entitled to different levels of service. For example, applications such as Facebook, Netflix, or IM may be accorded higher priority (e.g., less subject to blocking).

At block 1504, access to a server by an application is controlled if the identified class matches a class indicated by the traffic routing policy. For example, if a traffic routing policy only applies to a certain class of mobile device, a UE applies the policy only if the device belongs to that class; otherwise the UE ignores the policy. In some aspects, the indicated class relates to at least one of: a device class, a subscription class, or an application class.

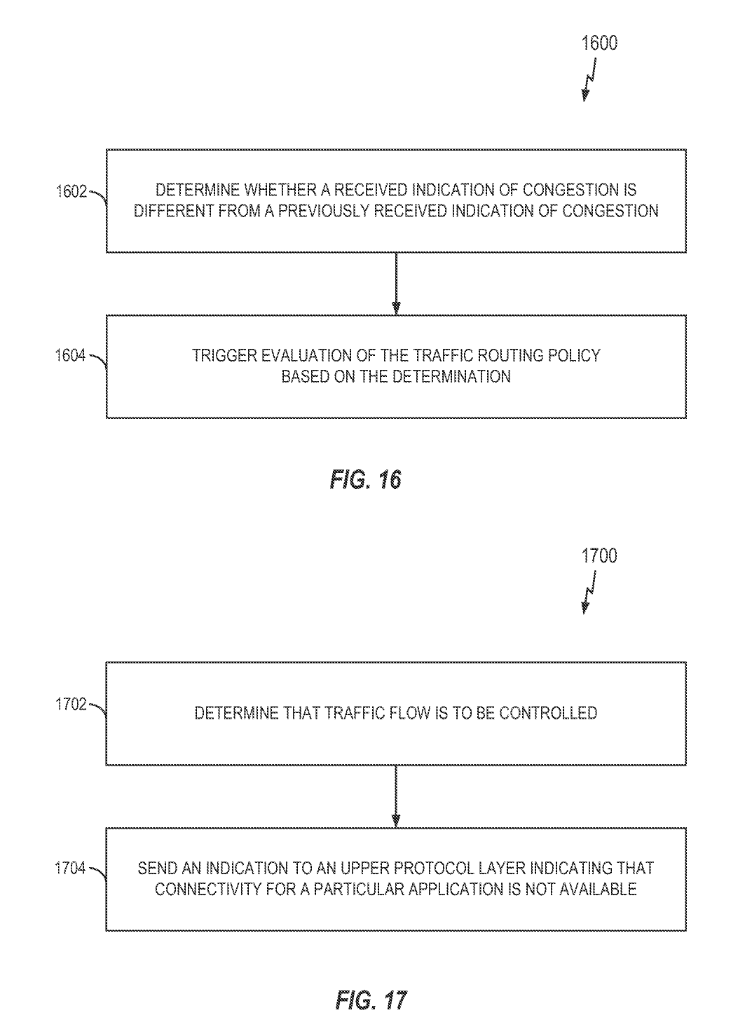

Referring to FIG. 16, in some aspects, a wireless communication device may re-evaluate a traffic routing policy. FIG. 16 illustrates a process 1600 for selectively evaluating a traffic routing policy in accordance with some aspects. The process 1600 may be performed in conjunction with the process 1100 of FIG. 11. The process 1600 may take place within a processing circuit (e.g., the processing circuit 1010 of FIG. 10), which may be located in a mobile device, or some other suitable apparatus. Of course, in various aspects within the scope of the disclosure, the process 1600 may be implemented by any suitable apparatus capable of supporting traffic control operations.

At block 1602, a determination is made as to whether a received indication of congestion is different from a previously received indication of congestion. For example, a UE may determine whether an ABI (e.g., indicative of whether there is congestion at a server) that was recently received is different from a prior ABI.

At block 1604, evaluation of the traffic routing policy is triggered based on the determination of block 1602. For example, a UE may perform a re-evaluation of the policy (e.g., determine whether certain application traffic should now be blocked or unblocked) if the ABI is different. As a specific example, a UE may unblock traffic from an application if the new ABI indicates no congestion and the previous ABI indicated congestion.

Referring to FIG. 17, in some aspects, an indication may be sent to an upper protocol layer indicating whether connectivity for a particular application is available. FIG. 17 illustrates a process 1700 for sending an indication in accordance with some aspects. The process 1700 may be performed in conjunction with the process 1100 of FIG. 11. The process 1700 may take place within a processing circuit (e.g., the processing circuit 1010 of FIG. 10), which may be located in a mobile device, or some other suitable apparatus. Of course, in various aspects within the scope of the disclosure, the process 1700 may be implemented by any suitable apparatus capable of supporting traffic control operations.

At block 1702, a determination is made that traffic flow is to be controlled. For example, the operations of block 1702 may correspond to the operations of block 1106 of FIG. 11.

At block 1704, an indication is sent to an upper protocol layer indicating that connectivity for a particular application is not available. Here, the indication is sent as a result of the determination of block 1702. For example, in the event block 1702 determines that traffic for a given application is to be blocked, an indication can be sent to an upper protocol layer indicating that connectivity for that application is not available.

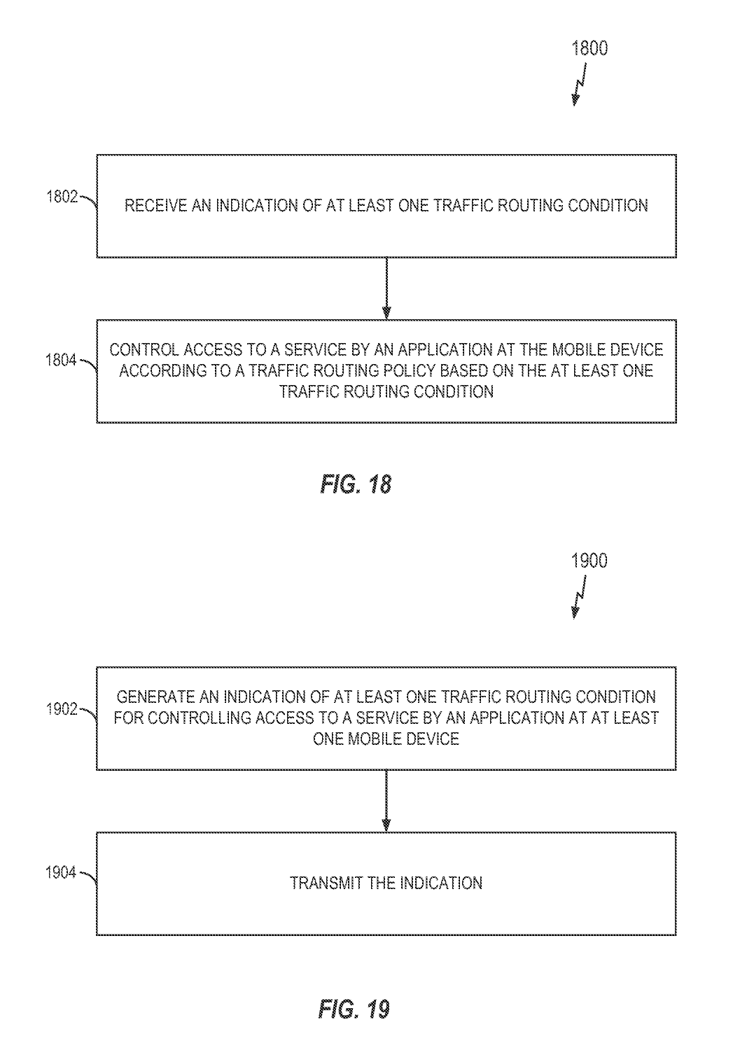

FIG. 18 illustrates another process 1800 for controlling traffic in accordance with some aspects. In some aspects, the operations of the process 1800 may correspond to one or more of the operations of the processes 1100-1700 of FIGS. 11-17. The process 1800 may take place within a processing circuit (e.g., the processing circuit 1010 of FIG. 10), which may be located in a mobile device, or some other suitable apparatus. Of course, in various aspects within the scope of the disclosure, the process 1800 may be implemented by any suitable apparatus capable of supporting traffic control operations.

At block 1802, an indication of at least one traffic routing condition (e.g., an indication of congestion at a server) is received. For example, a UE may receive this indication via broadcast signaling or unicast signaling.

At block 1804, access to a service by an application at the mobile device is controlled according to a traffic routing policy based on the at least one traffic routing condition. For example, traffic flow from the application to the service may be limited (e.g., entirely blocked or selectively blocked) if a specified condition (e.g., congestion associated with the service) occurs.

FIG. 19 illustrates a process 1900 for controlling traffic in accordance with some aspects. In some aspects, the process 1900 may provide information received by the process 1800 of FIG. 18 and/or one or more of the processes 1100-1700 of FIGS. 11-17. The process 1900 may take place within a processing circuit (e.g., the processing circuit 1010 of FIG. 10), which may be located in a network node, or some other suitable apparatus. Of course, in various aspects within the scope of the disclosure, the process 1900 may be implemented by any suitable apparatus capable of supporting traffic control operations.

At block 1902, an indication of at least one traffic routing condition (e.g., an indication of congestion at a server) is generated. For example, a network entity (e.g., a traffic management entity) may generate the indication or a serving access point for a UE may generate a message including this information. In some aspects, the indication is for controlling access to a service by an application at at least one mobile device. In some aspects, the controlling of access includes limiting traffic flow from the application to the service.

At block 1904, the indication generated at block 1902 is transmitted. For example, a network entity (e.g., a traffic management entity) may transmit (send) the indication to access points in a network for subsequent transmission to one or more UEs in the network. As another example, a serving access point for a UE may transmit a message including this information via broadcast signaling or unicast signaling.

In some implementations, the transmission of the indication involves invoking the transmission of multiple instances of the indication via different radio access technologies. In some implementations, the transmission of the indication involves transmitting the indication via a broadcast message, a unicast message, or layer 2 signaling.

In some implementations, the process 1900 further includes generating a traffic routing policy based on the indication and transmitting the traffic routing policy. In some implementations, the process 1900 further includes receiving a request for the indication, wherein the generation of the indication is a result of the receipt of the request.

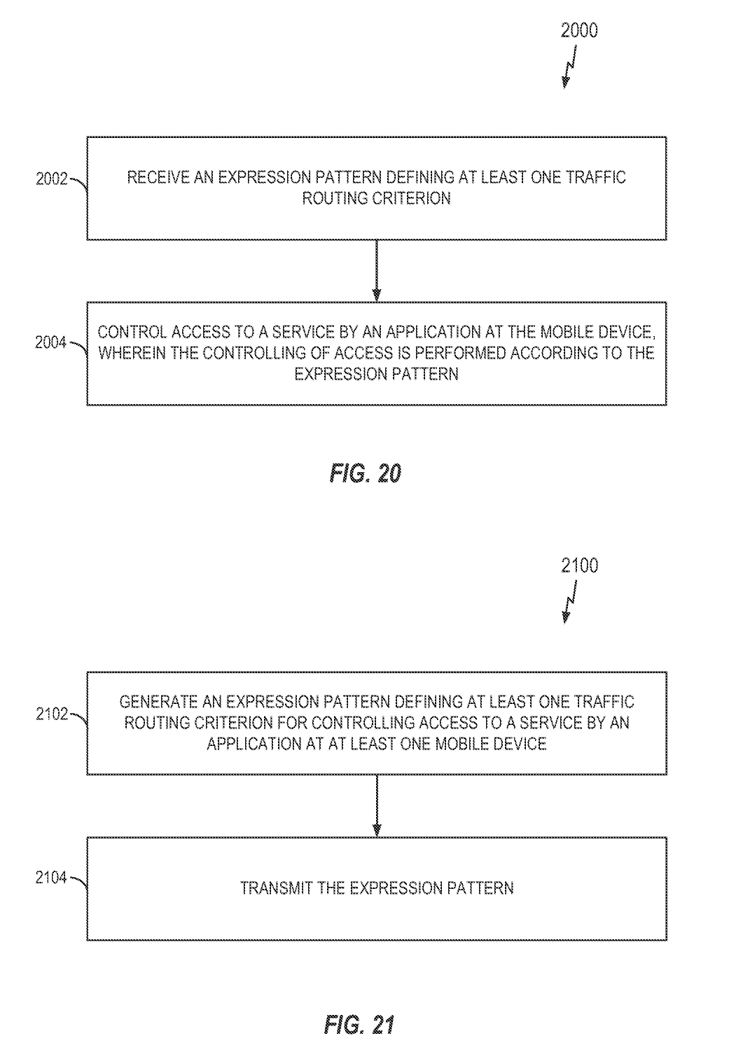

FIG. 20 illustrates a process 2000 for controlling traffic in accordance with some aspects. In some aspects, the operations of the process 2000 may correspond to one or more of the operations of the processes 1100-1700 of FIGS. 11-17. The process 2000 may take place within a processing circuit (e.g., the processing circuit 1010 of FIG. 10), which may be located in a mobile device, or some other suitable apparatus. Of course, in various aspects within the scope of the disclosure, the process 2000 may be implemented by any suitable apparatus capable of supporting traffic control operations.

At block 2002, an expression pattern defining at least one traffic routing criterion (e.g., a traffic routing policy) is received. For example, a UE may receive this expression pattern via broadcast signaling or unicast signaling.

At block 2004, access to a service by an application at the mobile device is controlled. In some aspects, the controlling of access is performed according to the expression pattern received at block 2002. For example, traffic flow from the application to the service may be limited (e.g., entirely blocked or selectively blocked) if a specified condition (e.g., congestion associated with the service) occurs.

In some implementations, the process 2000 further includes receiving an indication of a condition associated with the at least one traffic routing criterion, wherein the controlling of access is dependent on the condition.

FIG. 21 illustrates a process 2100 for controlling traffic in accordance with some aspects. In some aspects, the process 2100 may provide information received by the process 2000 of FIG. 20 and/or one or more of the processes 1100-1700 of FIGS. 11-17. The process 2100 may take place within a processing circuit (e.g., the processing circuit 1010 of FIG. 10), which may be located in an access point (e.g., an eNB), or some other suitable apparatus. Of course, in various aspects within the scope of the disclosure, the process 2100 may be implemented by any suitable apparatus capable of supporting traffic control operations.

At block 2102, an expression pattern defining at least one traffic routing criterion (e.g., a traffic routing policy) is generated. For example, a network entity (e.g., a traffic management entity) may generate the expression pattern or a serving access point for a UE may generate a message including this information. In some aspects, the expression pattern is for controlling access to a service by an application at at least one mobile device.

At block 2104, the expression pattern generated at block 2102 is transmitted. For example, a network entity (e.g., a traffic management entity) may transmit (send) the expression pattern to access points in a network for subsequent transmission to one or more UEs in the network. As another example, a serving access point for a UE may transmit a message including this expression pattern via broadcast signaling or unicast signaling. In some implementations, the transmission of the expression pattern involves invoking the transmission of multiple instances of the expression pattern via different radio access technologies.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein. Additional elements, components, steps, and/or functions may also be added or not utilized without departing from the disclosure.

While features of the disclosure may have been discussed relative to certain implementations and figures, all implementations of the disclosure can include one or more of the advantageous features discussed herein. In other words, while one or more implementations may have been discussed as having certain advantageous features, one or more of such features may also be used in accordance with any of the various implementations discussed herein. In similar fashion, while exemplary implementations may have been discussed herein as device, system, or method implementations, it should be understood that such exemplary implementations can be implemented in various devices, systems, and methods.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. In some aspects, a process may correspond to a method, a function, a procedure, a subroutine, a subprogram, etc. When a process corresponds to a function, its termination corresponds to a return of the function to the calling function or the main function. One or more of the various methods described herein may be partially or fully implemented by programming (e.g., instructions and/or data) that may be stored in a machine-readable, computer-readable, and/or processor-readable storage medium, and executed by one or more processors, machines and/or devices.

Those of skill in the art would further appreciate that the various illustrative logical blocks, modules, circuits, and algorithm steps described in connection with the implementations disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

Within the disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first die may be coupled to a second die in a package even though the first die is never directly physically in contact with the second die. The terms “circuit” and “circuitry” are used broadly, and intended to include both hardware implementations of electrical devices and conductors that, when connected and configured, enable the performance of the functions described in the disclosure, without limitation as to the type of electronic circuits, as well as software implementations of information and instructions that, when executed by a processor, enable the performance of the functions described in the disclosure.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

Accordingly, the various features associate with the examples described herein and shown in the accompanying drawings can be implemented in different examples and implementations without departing from the scope of the disclosure. Therefore, although certain specific constructions and arrangements have been described and shown in the accompanying drawings, such implementations are merely illustrative and not restrictive of the scope of the disclosure, since various other additions and modifications to, and deletions from, the described implementations will be apparent to one of ordinary skill in the art. Thus, the scope of the disclosure is only determined by the literal language, and legal equivalents, of the claims which follow.

What is claimed is:

1. A method operable at a wireless communication device for controlling traffic, comprising:
receiving a traffic routing policy;
receiving an indication of congestion at a server; and
determining whether to control traffic flow to the server based on the traffic routing policy and the indication of congestion.

2. The method of claim 1, further comprising:
limiting traffic flow from an application to the server as a result of the determination.

3. The method of claim 2, wherein the limiting of traffic flow comprises completely blocking the traffic flow or blocking a specific access by the application.

4. The method of claim 1, wherein the traffic routing policy comprises at least one of: an application identifier, a service identifier, a domain identifier, or combinations thereof.

5. The method of claim 1, wherein:
the traffic routing policy indicates traffic to be controlled; and
the method further comprises controlling flow of the indicated traffic from an application to the server as a result of the determination.

6. The method of claim 1, wherein the traffic routing policy comprises an expression pattern defining at least one traffic control criterion.

7. The method of claim 1, wherein:
the traffic routing policy indicates a preferred access for particular traffic; and
the method further comprises routing the particular traffic according to the indicated preferred access.

8. The method of claim 7, wherein the indicated preferred access overrides a corresponding traffic routing policy previously configured at the wireless communication device.

9. The method of claim 1, wherein:
the traffic routing policy indicates a class;
the method further comprises identifying a class associated with the wireless communication device; and
the method further comprises controlling access to the server by an application if the identified class matches the indicated class.

10. The method of claim 9, wherein each class relates to at least one of: a device class, a subscription class, an application class, or combinations thereof.

11. The method of claim 1, further comprising:
determining whether the indication is different from a previously received indication of congestion; and
triggering evaluation of the traffic routing policy based on the determination of whether the indication is different.

12. The method of claim 1, further comprising:
sending another indication to an upper protocol layer indicating that connectivity for a particular application is not available,
wherein the other indication is sent as a result of the determination.

13. An apparatus for controlling traffic at a wireless communication device, comprising:
a memory device;
a processing circuit coupled to the memory device and configured to:
receive a traffic routing policy;
receive an indication of congestion at a server; and
determine whether to control traffic flow to the server based on the traffic routing policy and the indication of congestion.

14. The apparatus of claim 13, wherein the processing circuit is further configured to:
limit traffic flow from an application to the server as a result of the determination.

15. The apparatus of claim 14, wherein, to limit the traffic flow, the processing circuit is further configured to completely block the traffic flow or block a specific access by the application.

16. The apparatus of claim 13, wherein the traffic routing policy comprises at least one of: an application identifier, a service identifier, a domain identifier, or combinations thereof.

17. The apparatus of claim 13, wherein:
the traffic routing policy indicates traffic to be controlled; and
the processing circuit is further configured to control flow of the indicated traffic from an application to the server as a result of the determination.

18. The apparatus of claim 13, wherein the traffic routing policy comprises an expression pattern defining at least one traffic control criterion.

19. The apparatus of claim 13, wherein:
the traffic routing policy indicates a preferred access for particular traffic; and
the processing circuit is further configured to route the particular traffic according to the indicated preferred access.

20. The apparatus of claim 19, wherein the indicated preferred access overrides a corresponding traffic routing policy previously configured at the wireless communication device.

21. The apparatus of claim 13, wherein:
the traffic routing policy indicates a class;
the processing circuit is further configured to identify a class associated with the wireless communication device; and
the processing circuit is further configured to control access to the server by an application if the identified class matches the indicated class.

22. The apparatus of claim 21, wherein each class relates to at least one of: a device class, a subscription class, an application class, or combinations thereof.

23. The apparatus of claim 13, wherein the processing circuit is further configured to:
determine whether the indication is different from a previously received indication of congestion; and
trigger evaluation of the traffic routing policy based on the determination of whether the indication is different.

24. The apparatus of claim 13, wherein:
the processing circuit is further configured to send another indication to an upper protocol layer indicating that connectivity for a particular application is not available; and
the other indication is sent as a result of the determination.

25. An apparatus for controlling traffic at a wireless communication device, comprising:
means for receiving, the means for receiving configured to receive a traffic routing policy and receive an indication of congestion at a server; and
means for determining whether to control traffic flow to the server based on the traffic routing policy and the indication of congestion.

26. The apparatus of claim 25, further comprising:
means for limiting traffic flow from an application to the server as a result of the determination.

27. The apparatus of claim 25, wherein:
the traffic routing policy indicates a preferred access for particular traffic; and
the apparatus further comprises means for routing the particular traffic according to the preferred access.

28. A non-transitory computer-readable medium storing computer executable code for controlling traffic at a wireless communication device, including code to:
receive a traffic routing policy;
receive an indication of congestion at a server; and
determine whether to control traffic flow to the server based on the traffic routing policy and the indication of congestion.

29. The computer-readable medium of claim 28, further comprising code to:
limit traffic flow from an application to the server as a result of the determination.

30. The computer-readable medium of claim 28, wherein:
the traffic routing policy indicates a preferred access for particular traffic; and
the computer-readable medium further comprises code to route the particular traffic according to the preferred access.
